(19) United States
(12) Patent Application Publication
(10) Pub. No.: US 2010/0322400 A1
(43) Pub. Date: Dec. 23, 2010

(54) Device,system,and method of routing telephone calls

(76) Inventor: Arik Katzenstein, Haifa (IL)

Correspondence Address: EITAN MEHULAL LAW GROUP, 10 Abba Eban Blvd. PO Box 2081, Herzlia, 46120, IL

(21) Appl. No.: 12/457,615

(22) Filed: Jun. 17, 2009

(51) Int. Cl. H04M 15/00; H04M 3/42

(52) U.S. Cl. 379/114.21; 379/211.01

(57) ABSTRACT

Device, system, and method of routing telephone calls. For example, a method of routing a telephone call includes: receiving from a first party a rejection profile, indicating that the first party wishes to reject an incoming telephone call which meet at least one criterion unless the first party is not charged for any charges associated with said incoming telephone call; receiving a request of a second party to place a telephone call to said first party, wherein the telephone call is expected to incur one or more charges to the first party; if the telephone call meets said at least one criterion of the rejection profile of the first party, notifying the second party that the telephone call is not routed to the first party unless the second party agrees to pay for all charges associated with said telephone call.

### FIELD

Some embodiments are related to the field of telecommunication.

### BACKGROUND

A telecommunication system allows a first party (“the calling party”) to initiate a telephone call directed to a second party (“the receiving party”). For example, the calling party may use a cellular phone or a landline phone, in order to call the receiving party who may use a cellular phone. The receiving party may be charged by his network provider for the n incoming call. For example, the receiving party may utilize a cellular phone, and may be charged by his cellular telephony provider once he answers the incoming call. The receiving party may thus be exposed to monetary charges for receiving telephone calls, or for merely answering briefly an incoming telephone call in order to find out who the caller is or what the caller wants.

Some telecommunication systems mitigate this situation by allowing the receiving party to subscribe to a “Caller ID” service, such that the receiving party may know, prior to answering the incoming telephone call, one or more details of the calling party (e.g., the telephone number of the caller, and optionally the listed name associated with number from which the call is placed). The receiving party may thus select, based on the Caller ID information, whether or not to answer the incoming telephone call.

Unfortunately, the Caller ID service may not be a suitable solution at all times. First, some telephony providers may charge the receiving party a subscription fee for using the “Caller ID” service. Second, the “Caller ID” service may be out-dated, inaccurate, or wrong; for example, showing details of a previous owner of the phone line; showing details of an employer (and not the employee who is calling); showing details of a landlord (and not the tenant who is calling); or the like. Third, the Caller ID data may be unavailable if the calling party selects to “hide” his details from the receiving party by “blocking” the Caller ID service (e.g., by dialing the prefix *67 in the United States). Fourth, the Caller ID data may be unavailable or partial if the calling party is located in a foreign country, thereby causing the Caller ID to sometime show “out of area” or “unavailable” instead of the actual details of the calling party.

Furthermore, the problem is compounded when the receiving party “roams” or travels out of his country. In such cases, he is exposed to high charges for incoming phone calls; and often the Caller ID feature does not function appropriately when the receiving party is located in a foreign country. The receiving party may instruct his network operator, to automatically reject any incoming phone calls unless the calling party dials a password that the receiving party had set and pre-provided to the calling party for this purpose. However, the resulting situation is that persons who would like to reach the receiving party, but do not have the required password, are entirely unable to reach him by phone. Additionally, the automatic rejection of incoming phone calls by callers who do not have the required password, results in a overly comprehensive rejection of phone calls that might be of interest to the receiving party.

### SUMMARY

Some embodiments include, for example, devices, systems, and methods of routing telephone calls

In some embodiments, for example, a method of routing a telephone call includes: receiving from a first party a rejection profile, indicating that the first party wishes to reject an incoming telephone call which meet at least one criterion unless the first party is not charged for any charges associated with said incoming telephone call; receiving a request of a second party to place a telephone call to said first party, wherein the telephone call is expected to incur one or more charges to the first party; if the telephone call meets said at least one criterion of the rejection profile of the first party, notifying the second party that the telephone call is not routed to the first party unless the second party agrees to pay for all charges associated with said telephone call.

In some embodiments, the method includes: obtaining acceptance of the second party to incur for all charges associated with said telephone call; and connecting said telephone call between the second party and the first party.

In some embodiments, the method includes: subsequent to obtaining the acceptance, and prior to connecting the telephone call, obtaining from the second party details of a payment method sufficient for collecting said charges from an account of the second party.

In some embodiments, the payment method is selected from the group consisting of: credit card of the second party, debit card of the second party, debit to a bank account of the second party, and debit to a telephony subscriber account of the second party.

In some embodiments, obtaining the details of the payment method comprises at least one of: activating an automated voice-operated user interface to receive said details from the second user through a telephony device of the second user; and activating an automated keypad-operated user interface to receive said details from the second user through a telephony device of the second user.

In some embodiments, the method includes, upon termination of said telephone call between the second party and the first party: calculating charges associated with said telephone call and allocated to the first party; notifying the second party of said calculated charges; and debiting said calculated charges to a subscriber account of the second party.

In some embodiments, the method includes, upon termination of said telephone call between the second party and the first party: if a subscriber account of the first party was debited for one or more charges, issuing a credit to the subscriber account of the first party in an amount substantially equal to said one or more charges.

In some embodiments, the at least one criterion is selected from the group consisting of: a geographical area in which the second party is located; at least a portion of a name of the second party; at least a portion of Caller ID information associated with the second party; an area code of the second party; an international dialing code of the second party; a time of day; and a day of week.

In some embodiments, the method includes, prior to obtaining the acceptance: estimating charges associated with said telephone call and intended to be allocated to the first party; notifying the second party of said estimated charges; and obtaining an acceptance of the second party to incur said estimated charges instead of the first party.

In some embodiments, receiving the rejection profile comprises receiving the rejection profile through a configuration process performed by the first party through at least one of: a telephone device of the first party; and an automated voice-operated interface; an automated keypad-based interface; and an Internet page associated with a subscriber account of the first party.

In some embodiments, a system for routing a telephone call includes: a network element to receive from a first party a rejection profile, indicating that the first party wishes to reject an incoming telephone call which meet at least one criterion unless the first party is not charged for any charges associated with said incoming telephone call; to receive a request of a second party to place a telephone call to said first party, wherein the telephone call is expected to incur one or more charges to the first party; and, if the telephone call meets said at least one criterion of the rejection profile of the first party, to notify the second party that the telephone call is not routed to the first party unless the second party agrees to pay for all charges associated with said telephone call.

In some embodiments, the network element is to obtain acceptance of the second party to incur for all charges associated with said telephone call; and to connect said telephone call between the second party and the first party.

In some embodiments, subsequent to obtaining the acceptance, and prior to connecting the telephone call, the network element is to obtain from the second party details of a payment method sufficient for collecting said charges from an account of the second party.

In some embodiments, the payment method is selected from the group consisting of: credit card of the second party, debit card of the second party, debit to a bank account of the second party, and debit to a telephony subscriber account of the second party.

In some embodiments, the network element is to activate at least one of: an automated voice-operated user interface to receive said details from the second user through a telephony device of the second user; and an automated keypad-operated user interface to receive said details from the second user through a telephony device of the second user.

In some embodiments, upon termination of said telephone call between the second party and the first party, the network element is to: calculate charges associated with said telephone call and allocated to the first party; notify the second party of said calculated charges; and debit said calculated charges to a subscriber account of the second party.

In some embodiments, upon termination of said telephone call between the second party and the first party, and if a subscriber account of the first party was debited for one or more charges, the network element is to issue a credit to the subscriber account of the first party in an amount substantially equal to said one or more charges.

In some embodiments, the at least one criterion is selected from the group consisting of: a geographical area in which the second party is located; at least a portion of a name of the second party; at least a portion of Caller ID information associated with the second party; an area code of the second party; an international dialing code of the second party; a time of day; and a day of week.

In some embodiments, prior to obtaining the acceptance, the network element is to: estimate charges associated with said telephone call and intended to be allocated to the first party; notify the second party of said estimated charges; and obtain an acceptance of the second party to incur said estimated charges instead of the first party.

In some embodiments, the network element is to receive the rejection profile through a configuration process performed by the first party through at least one of: a telephone device of the first party; and an automated voice-operated interface; an automated keypad-based interface; and an Internet page associated with a subscriber account of the first party.

Some embodiments may include, for example, a computer program product including a computer-useable medium including a computer-readable program, wherein the computer-readable program when executed on a computer causes the computer to perform methods in accordance with some embodiments.

Some embodiments may provide other and/or additional benefits and/or advantages.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system in accordance with some demonstrative embodiments.

FIG. 2 is a schematic flow-chart of a method of routing telephone calls, in accordance with some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

The terms “plurality” or “a plurality” as used herein include, for example, “multiple” or “two or more”. For example, “a plurality of items” includes two or more items.

Although portions of the discussion herein relate, for demonstrative purposes, to wired links and/or wired communications, some embodiments are not limited in this regard, and may include one or more wired or wireless links, may utilize one or more components of wireless communication, may utilize one or more methods or protocols of wireless communication, or the like. Some embodiments may utilize wired communication and/or wireless communication.

Some embodiments may be used in conjunction with various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device (e.g., a device incorporating functionalities of multiple types of devices, for example, PDA functionality and cellular phone functionality), a vehicular device, a non-vehicular device, a mobile or portable device, a non-mobile or non-portable device, a wireless communication station, a wireless communication device, a wireless Access Point (AP), a wireless Base Station (BS), a Mobile Subscriber Station (MSS), a wired or wireless Network Interface Card (NIC), a wired or wireless router, a wired or wireless modem, a wired or wireless network, a Local Area Network (LAN), a Wireless LAN (WLAN), a Metropolitan Area Network (MAN), a Wireless MAN (WMAN), a Wide Area Network (WAN), a Wireless WAN (WWAN), a Personal Area Network (PAN), a Wireless PAN (WPAN), devices and/or networks operating in accordance with existing IEEE 802.11, 802.11a, 802.11b, 802.11g, 802.11n, 802.16, 802.16d, 802.16e, 802.16m standards and/or future versions and/or derivatives of the above standards, units and/or devices which are part of the above networks, one way and/or two-way radio communication systems, cellular radio-telephone communication systems, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or tag or transponder, a device which utilizes Near-Field Communication (NFC), a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, a “smartphone” device, a wired or wireless handheld device (e.g., BlackBerry (RTM), Palm (RTM) Treo (TM)), a Wireless Application Protocol (WAP) device, or the like.

Some embodiments may be used in conjunction with one or more types of wireless communication signals and/or systems, for example, Radio Frequency (RF), Infra Red (IR), Frequency-Division Multiplexing (FDM), Orthogonal FDM (OFDM), OFDM Access (OFDMA), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, Multi-Carrier Modulation (MDM), Discrete Multi-Tone (DMT), Bluetooth (RTM), Global Positioning System (GPS), IEEE 802.11 (“Wi-Fi”), IEEE 802.16 (“Wi-Max”), ZigBee (TM), Ultra-Wideband (UWB), Global System for Mobile communication (GSM), 2G, 2.5G, 3G, Third Generation Partnership Project (3GPP), 3GPP Long Term Evolution (LTE), 3.5G, or the like. Some embodiments may be used in conjunction with various other devices, systems and/or networks.

The terms “wireless device” or “mobile device” or “telephony device” as used herein include, for example, a device capable of wireless communication, a device capable of wired communication, a communication device or communication station capable of wired and/or wireless communication, a mobile phone, a cellular phone, a laptop or notebook computer capable of wireless and/or wired communication, a PDA capable of wireless and/or wired communication, a handheld device capable of wireless and/or wired communication, a “smartphone”, a portable or non-portable device capable of wireless and/or wired communication, a device from which an outgoing telephone call may be placed, a device on which an incoming telephone call may be received, a device capable of Voice over IP (VoIP) communication or telephone, or the like.

The term “network element” as used herein includes, for example, one or more components or modules of a telecommunication network; a router; a switch; a hub; a switching point; a Network Control Center (NCC); a Multimedia Message Service Center (MMSC); a Short Message Service Center (SMSC); a Radio Network Controller (RNC); a cell of a cellular network; a base station of a wireless network; an Access Point; a link or a set of links of a telecommunication network; or the like.

The term “user” as used herein includes, for example, a person or entity that owns a telephony device; a person or entity that operates or utilizes a telephony device; or a person or entity that is otherwise associated with a telephony device.

The terms “calling party” or “caller” as used herein include, for example, a user who initiates or dials or places an outgoing telephone call.

The terms “receiving party” or “destination party” as used herein include, for example, a user who receives an incoming telephone call; a user who answers an incoming telephone call; a user whose telephony device rings or otherwise indicates (e.g., by vibrating) that a telephone call is incoming, regardless of whether the user answered the call, actively rejected the call, or passively ignored the call.

Some embodiments may be used in conjunction with a variety of telephony networks, for example, cellular networks, mobile phone networks, Public Switched Telephone Network (PSTN), circuit-switched telephone networks, IP-based networks, Internet-based networks, Voice over IP (VoIP) networks, packet-switched networks or telephone networks, a global communication network, a wired network, a wireless network, a combination of one or more wired networks and/or one or more wireless networks, a shared access medium, an a-synchronic or asynchronous wireless network, a synchronic wireless network, a managed wireless network, a non-managed wireless network, a burstable wireless network, a non-burstable wireless network, a scheduled wireless network, a non-scheduled wireless network, or other suitable communication networks and/or combinations thereof.

Devices 101-104 are able to access a communication network 190 through wired and/or wireless links 191-194, respectively. Communication network 190 may be or may include, for example, a global communication network, the Internet, the World Wide Web, a wired network, a wireless network, a combination of one or more wired networks and/or one or more wireless networks, a shared access medium, or the like. In some embodiments, communication network 190 may include one or more wired and/or wireless communication networks, for example, an a-synchronic or asynchronous wireless network, a synchronic wireless network, a managed wireless network, a non-managed wireless network, a burstable wireless network, a non-burstable wireless network, a scheduled wireless network, a nonscheduled wireless network, or the like.

At an overview, some embodiments include devices, systems, and methods of routing telephone calls. Particularly, some embodiments may operate to ensure that a receiving party is not charged at all for an incoming telephone call, and that all tolls which may be associated with such incoming telephone call are not incurred by the receiving party but, rather, are incurred by the calling party who initiated the telephone calls.

For example, the receiving party may utilize his mobile telephone to indicate that he does not agree to be charged for any incoming calls, or for incoming calls from certain geographical origins (e.g., countries, states, cities, or other regions), from certain individuals (e.g., callers having the word “marketing” in their Caller ID name), from certain numbers (e.g., from numbers that originate from a particular area code or international code), at certain times (e.g., at night time), at certain days (e.g., on Sundays), or the like.

A calling party may attempt to place a telephone call to such receiving party. The telephone call may not be routed directly to the receiving party. Instead, the telecommunication network identifies that the receiving party prohibited to be charged for any incoming calls. The network may notify the calling party that the receiving party does not agree to be charged for the call, and offers to the calling party—through an automated interface or through a human operator—that the calling party may utilize his credit card or other payment method in order to incur all the relevant charges, including charges that by default are allocated to the receiving party. Only if the calling party agrees to incur all such charges, and optionally provides a payment means to cover such charges (e.g., credit card, debit card, direct debit through a bank account, debit through a telephone bill of the calling party, or the like), the network proceeds to connect the calling party to the receiving party.

In some embodiments, the calling party may indicate in advance, upon placing the telephone call (e.g., by dialing a particular prefix or suffix or other code), that he wishes to incur all the relevant charges, such that the receiving party will not be charged for the call. In such case, the network may operate to ensure that all charges associated with the call are indeed incurred by the calling party, and not by the receiving party. Optionally, the network may connect the calling party to the receiving party, together with indicating to the receiving party that this incoming call is fully paid by the calling party, and not by the receiving party.

In some embodiments, the system operates to ensure that the receiving party is not charged for an incoming call, directly or indirectly, and that all charges associated with.

The call are incurred by the calling party. This may include, in some embodiments, creating a monetary debit to the calling party for all charges associated with the call, including for portions of the charge that are typically debited to the receiving party. In some embodiments, the receiving party may be debited for charges associated with the incoming call, by may be credited back or refunded for such debited charges, substantially immediately or within a short period of time (e.g., minutes or hours), optionally using a clearinghouse that ensures that the calling party is fully debited and that the receiving party is not debited at all for the call.

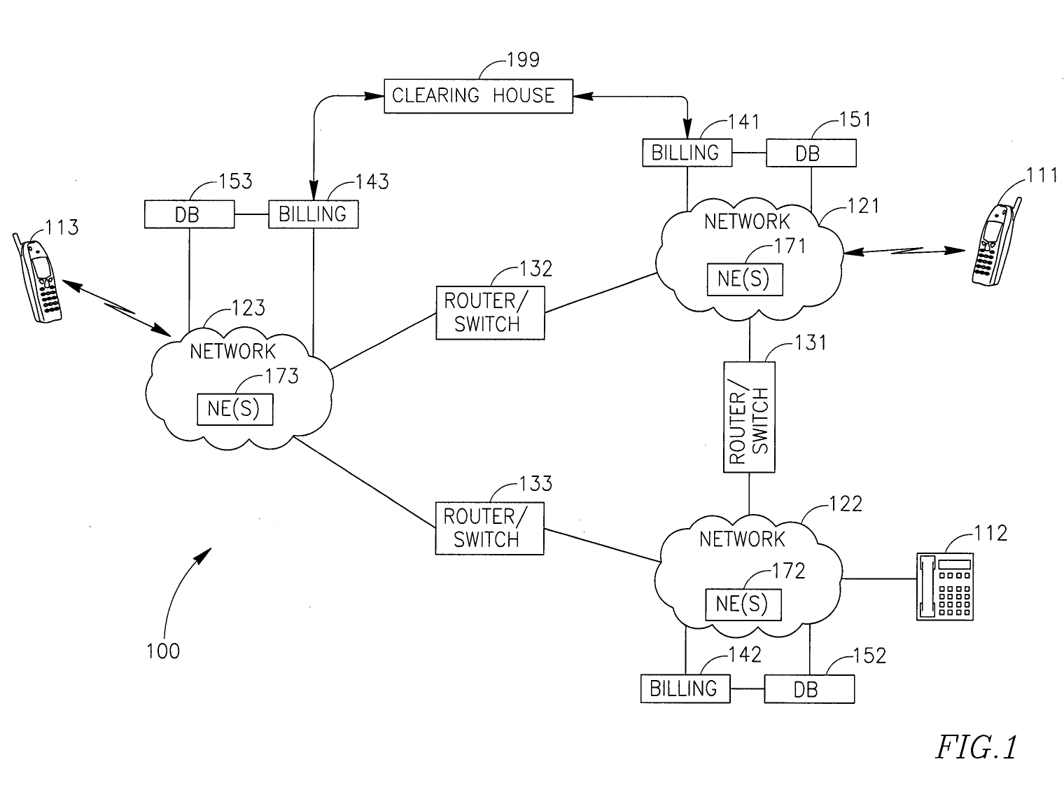

FIG. 1 schematically illustrates a block diagram of a system 100 in accordance with some demonstrative embodiments. System 100 includes multiple telephony devices, for example, devices 111-113.

Device 111 may be a mobile phone, operated by a calling party, named Charles. Device 111 may be associated with a cellular network 121; for example, the calling party Charles may be a subscriber of the cellular network 121. Network 121 may include one or more suitable Network Elements (NEs) 171.

Device 112 may be a landline phone (e.g., a Plain Old Telephone Service (POTS) device), operated by another calling party, named Carter. Device 112 may be associated with a wired telephony network 122 (e.g., a Public Switched Telephone Network (PSTN) or other circuit-switched telephone network); for example, the calling party Carter may be a subscriber of the wired telephony network 122. Network 122 may include one or more suitable Network Elements (NEs) 172.

Device 113 may be a mobile phone, operated by a receiving party, named Rachel Device 113 may be associated with a cellular network 123; for example, the receiving party Rachel may be a subscriber of the cellular network 123. Network 123 may include one or more suitable Network Elements (NEs) 173.

Networks 121-123 may communicate among themselves, and may route or transfer telephone calls from one network to another, using suitable Network Elements (NEs) and network protocol(s). For example, a router/switch 131 may operate to connect between network 121 and network 122; a router/switch 132 may operate to connect between network 121 and network 122; and a router/switch 133 may operate to connect between network 122 and network 123. Other suitable network elements may be used, within networks 121-123 or among them.

Each one of networks 121-123 may be associated with a corresponding database 151-153, respectively, able to store data about subscribers of that network 121-123 and about the activities or such subscribers. For example, database 151 may store data about subscribers of network 121, their service plans, logs of incoming calls, logs of outgoing calls, logs of missed calls, logs of call durations, charges associated with incoming calls, charges associated with outgoing calls, or the like. Similarly, database 152 may store such data about subscribers of network 122; and database 153 may store such data about subscribers of network 123.

Each one of networks 121-123 may further be associated with a corresponding billing module 141-143, respectively, able to handle billing and billing-related operations with regard to subscribers of that network 121-123, for example, bill production, collection of payments, issuing debits to subscribers, issuing credits to subscribers, or the like.

Receiving party Rachel of mobile phone 113 may notify the operator of network 123 that she does not agree to be debited or to incur any toll for incoming phone calls. The notification may be conveyed by Rachel, for example, using Rachel's mobile phone 113; using a web-page on the web-site of network 123 which allows Rachel to set or modify properties or preferences related to utilization of her mobile phone 123; using a request via phone or fax or letter or email to a customer service center of network 123; using an automated interface or a dial-tone interface or a voice-operated interface; or the like. Upon receipt of Rachel's notification, network 123 may update the database 153 to indicate that Rachel does not agree to incur any toll for incoming phone calls.

In some embodiments, the notification and the indication may relate to substantially all incoming phone calls. In other embodiments, the notification and the indication may relate or may apply to particular characteristics of incoming phone calls, set by Rachel. For example, the receiving party Rachel may indicate that she does not agree to be charged for incoming calls from certain geographical origins (e.g., foreign countries, certain countries, certain states, certain cities, or certain other regions), from certain individuals (e.g., callers having the word “marketing” in their Caller ID name), from certain numbers (e.g., from numbers that originate from a particular area code or a particular international code), at certain times (e.g., at night time), at certain days (e.g., on Sundays), or the like.

The calling party Charles utilizes his mobile phone 111 to dial the mobile phone number of Rachel, in an attempt to call her. The mobile phone 111 of Charles connects to the cellular network 121 (of which Charles is a subscriber); and network 121 in turn connects to, or routes the call to, network 163 (of which Rachel is a subscriber), directly or indirectly, e.g., using the router/switch 132 or other network elements.

Network 163 does not immediately route the call to Rachel's mobile phone 113. Instead, network 163 checks in its database 153, whether or not Rachel notified that she does not agree to be charged for calls incoming to her mobile device 113. Based on the prior notification by Rachel, which is stored or otherwise indicated in the database 153, network 163 determines that Rachel does not agree to be charged for calls incoming to her mobile device 113.

Network 163 sends back a “rejection response” to mobile device 111 of calling party Charles, either directly or indirectly through network 121. The rejection response indicates to Charles that Rachel does not agree to be charged for the phone call that the calling party Charles attempts to place towards Rachel's mobile device 113. The rejection response may be, for example, a pre-recorded audio message, a voice message, a text message, a human response, or the like.

In some embodiments, the rejection response may include, or may be followed by or coupled to, an interface allowing Charles to perform operations such that all toll and charges for the phone call that Charles attempts to place towards Rachel's mobile phone 113, will be charged exclusively to Charles, and will not be charged (in whole or in part) to Rachel. For example, a dial-tone or touch-tone interface, or a voice-operated interface, or a human operator, may present to Charles the option to proceed with placing the call to Rachel, if Charles agrees to pay for all tolls and charges using, for example, his credit card, debit card, direct debit from his bank account, direct debit through his phone bill, or the like.

If Charles agrees, namely, indicates that he wishes that this call will be “fully paid by the calling party”, and provides the relevant details for such charging (e.g., his credit card number, type, and expiration data), then networks 121 may proceed to perform the suitable operations, namely: to issue a debit to Charles for all the charges associated with the call (if known in advance), and/or to notify network 163 that the calling party agrees to pay for all the charges associated with this call to Rachel. Network 163 may receive this notification of “fully paid by the calling party” from network 161, and network 163 may proceed to connect the call to Rachel.

Since Rachel already notified the network 163, that she does not agree to be charged for incoming phone calls, Rachel may determine that the incoming phone call on her mobile device 113 is fully paid by the calling party; otherwise, the call would not have been routed through to her mobile device, which would not have rung. Rachel may use her mobile phone 113 to answer the phone call that was initiated by Charles, and to speak with Charles by phone.

Subsequently, the phone call ends, for example, if Rachel terminates the call, if Charles terminates the call, or due to a communication breakdown. Once the phone call ended, network 163 logs the duration of the call, and calculates (using the billing module 143) the monetary amount of charges and tolls that Rachel would have incurred had she agreed to pay for that incoming call (“incoming call charges”). In some embodiments, billing module 143 of network 163 may issue a debit, in the amount of the call charges (and optionally with a surcharge or a margin of profit to the operator of network 163) to the billing module 141 of network 121, directly or indirectly (e.g., via a clearinghouse 199). The debit identifies the amount charged, the duration of the call, the phone number of the receiving party Rachel, and the phone number of the calling party Charles.

In some embodiments, network 121 may notify the calling party Charles the monetary amount charged or debited to him for the phone call that he just placed and ended; or, particularly, of monetary amount charged or debited to him instead of being debited or charged to the receiving party Rachel. The notification may be, for example, by an automated audio notification (e.g., using a text-to-speech module), using a textual or SMS message, or the like.

The billing module 141 of network 121 may receive the debit, and may issue (e.g., back-to-back) a similar debit to the account of the subscriber who was the calling party for that call, namely, to Charles. Optionally, the debit issued by billing module 141 to Charles may be greater than the debit issued by billing module 143 to billing module 141, to reflect a surcharge or a margin of profit to the operator of network 121. In some embodiments, the debit issued to Charles by the billing module 141 is automatically debited to the method of payment that Charles selected once he got a “rejection response” and was requested to provide a method of payment for the call.

In some embodiments, the billing module 141 of network 121 automatically pays to the billing module 143 of network 143 the amount that billing module 143 debited to billing module 141, without waiting for collection of that (or a greater) debit by billing module 141 from Charles, or without dependency on actual payment by Charles of that (or a greater) debit by billing module 141. In other embodiments, the payment from billing module 141 to billing module 143 may be delayed until actual collection from Charles; may be aggregated into a set of similar payments paid together; may be aggregated until periodic pay-dates; may be settled directly, or indirectly through clearing house 199, or the like. In some embodiments, billing module 141 does not collect from Charles all the required tolls for the phone call; instead, billing module 141 collects from Charles only the charges associated directly with network 121; and billing module 141 instructs the billing module 143 to directly collect from Charles the charges associated with network 123 (and billing module 123 may do so, subsequently).

In some embodiments, billing module 143 ensures that Rachel is not debited for the incoming phone call that she “rejected” in advance by refusing to pay for incoming calls. For example, billing module 143 may avoid debiting Rachel's subscriber account for any charges actually incurred in that phone call; or, billing module 143 may debit Rachel's subscriber account for such charges by may issue to her (e.g., substantially immediately, or within a few minutes or hours) a credit to entirely offset the debit. In some embodiments, the credit may be applied substantially immediately; in other embodiments, the credit may be applied only after the billing module 143 debited the relevant charges, either to billing module 141 or to Charles, or after the billing module 143 actually received the relevant charges, either from billing module 141 or from Charles.

In some embodiments, Rachel may easily activate and/or deactivate her notification of refusal to pay for incoming phone calls. For example, Rachel may be able to modify this property through a “setup” or “configuration” or “preferences” function in her mobile phone 113 or through the web-site of the operator of network 123. In some embodiments, Rachel may dial a particular number or prefix (e.g., “star” followed by two or three digits) in order to activate and/or deactivate the refusal to pay for incoming phone calls.

In some embodiments, Rachel may be able to notify the network 123, that she agrees to pay only a particular amount of charges (e.g., total, or per time unit) for incoming phone calls, or for a particular incoming phone call, or for a particular type of incoming phone calls. In such cases, networks 123 and 121 may convey to the calling party Charles that a portion of the charges that are typically allocated to the receiving party, are to be debited to the calling party Charles if he selects to proceed and place the call. Then, billing modules 143 and 141 may operate to collect from Rachel the portion of the charges that she agreed to pay for the incoming call, and to further collect from Charles the remaining portion of the charges for that phone call (including the portion which Rachel should have incurred but refused in advance).

In some embodiments, the database 153 may store a “rejection profile” associated with the subscriber Rachel as receiving party. For example, Rachel may utilize her mobile phone 113 or the web-site of the operator of network 123, in order to set and/or modify conditions for rejection (or acceptance) of incoming calls, e.g., based on geographical origin of caller, name of caller, phone number of caller, area code of caller, international code of caller, time of day, day of week, or the like. Once the calling party Charles initiates a call to the receiving party Rachel, the network 123 retrieves the “rejection profile” of Rachel from the database 153 (prior to allowing the call to reach Rachel's mobile phone 113), and checks whether the incoming call is to be rejected back to the calling party or allowed to be routed through to Rachel's mobile phone 113. If the phone call is rejected, the system may perform the operations described above, for example, offering to the calling party Charles to incur all the charges associated with the phone call, including the charges that should have been charged to Rachel's subscriber account.

In some embodiments, once the phone call is automatically “rejected” by network 123, the calling party may be presented not only with the offer to pay in full for all the charges of the call, but with an estimated cost of such charges, or of the additional charges incurred on him instead of on the receiving party Rachel. For example, when network 123 rejects the incoming phone call, network 123 may check, based on the billing module 143 and/or the database 153, what is the estimated rate (e.g., per second, per minute, flat rate, or the like) that the receiving party Rachel is expected to be charged for such incoming call; and network 123 may transfer this estimated rate back to network 121, which may convey this information to the calling party Charles. For example, the calling party Charles may be presented with an audio announcement, indicating that the receiving party refuses to pay for any charges associated with this phone call, and that the calling party is offered to incur such charges instead of the receiving party, the charges estimated at a particular rate (e.g., dollars or cents per minute) included in the audio announcement. This may allow the calling party Charles to take into account the estimated extra charge for the call, when considering whether or not to pay for in full for total charges of the phone call.

In some embodiments, the calling party Charles may know in advance, that the receiving party Rachel had configured her mobile phone 113 and/or her cellular network 123 to automatically reject incoming calls (e.g., all incoming calls, or calls incoming from Charles, or calls from particular origins, or the like) unless the calling party pays in full for all the charges of such call. For example, the calling party Charles may know in advance, that the receiving party Rachel is located in a foreign country, and had activated her “incoming call rejection profile” in order to save costs for herself. In some embodiments, the calling party Charles may dial, in addition to the phone number of Rachel's mobile phone 113, an addendum code (e.g., a prefix, a suffix, or a code entered upon prompting by an automated system). The addendum code may be a pre-indication, to the networks 121 and 123, that the calling party Charles would like to pay for all the costs associated with this call, including with the costs that are typically incurred by the receiving party. Based on the code, the calling party may be routed to an automated interface to collect his credit card details or other payment method details; or may be routed to an automated billing interface which receives the consent of the calling party Charles that the total costs of this phone call will be debited to the monthly bill of his subscriber account with network 121; or may be routed to a human operator to obtain from the calling party Charles his consent and/or his method of payment for the total charges of the call. Then, once the calling party Charles conveys his consent to proceed, and provides his payment method, network 121 may indicate to network 123 that the calling party agreed to incur all the costs for this phone call, and that the payment method was successfully obtained from the calling party, such that network 121 is requested to allow the phone call to be routed to its destination, namely, the receiving party. Some embodiments may thus provide a mechanism allowing the calling party to create and send out an early notification of his agreement to pay for the entire charges of this phone call, prior to (and without) receiving any “rejection response”. This may allow the calling party to save time, for example, if he knows in advance that a phone call that he is about to initiate is expected to receive a “rejection response” that the calling party intends to accept.

Although portions of the discussion herein relate, for demonstrative purposes, to routing and handling of a phone call placed by the calling party Charles having a mobile phone 111, similar principles may be applied to a phone call placed by the calling party Carter having landline phone 112. For example, the telecommunication network 122 (and its billing module 142 and/or database 152) may handle some of the functions that were described in relation to the cellular network 121 (and its billing module 141 and/or database 151).

In some embodiments, the receiving party Rachel may notify the network 123, that the “rejection profile” is to be automatically activated if the receiving party Rachel is “roaming” away from her base location or is in a foreign country; and that the “rejection profile” is to be automatically deactivated if the receiving party Rachel is not “roaming” or is not n a foreign country. This condition may be stored in the database 153 in association with the “rejection profile”, indicating that the rejection profile is conditional. Once the network 123 detects that the receiving party Rachel is “roaming” or is in a foreign country, the network 123 updates the database 153 to indicate that the rejection profile is now activated. In contrast, once the network 123 detects that the receiving party Rachel is no longer “roaming” or no longer in a foreign country, the network 123 updates the database to indicate that the rejection profile is now deactivated.

In some embodiments, each one of devices 111-113 may include suitable hardware and/or software components, for example: a processor; a memory unit; a storage unit; a wired or wireless transceiver; one or more antennas; a microphone to receive audio; a speaker to output audio; an output unit (e.g., a screen or a display panel); an input unit (e.g., a keypad or a touch screen); and optionally an Operating System (OS) and one or more applications.

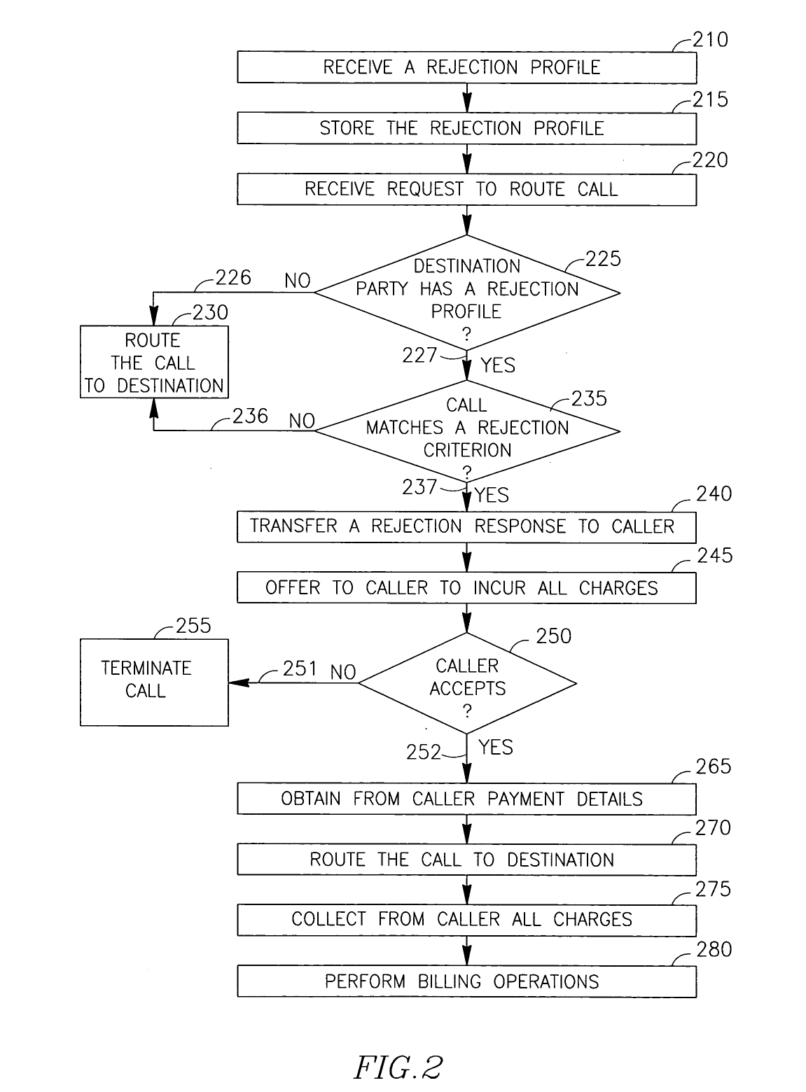

FIG. 2 is a schematic flow-chart of a method of routing telephone calls, in accordance with some demonstrative embodiments. Operations of the method may be performed, for example, by one or more components of FIG. 1.

In some embodiments, the method may include, for example, receiving a “rejection profile” from a user of a telephony device (namely, from the receiving party) (block 210). For example, the receiving party notifies its network operator that the receiving party refuses to receive incoming calls that require the receiving party to incur any charge.

In some embodiments, the method may include, for example, storing in a network database a representation of the rejection profile (block 215).

In some embodiments, the method may include, for example, receiving an incoming request to route an incoming phone call to a destination party (block 220).

In some embodiments, the method may include, for example, checking whether or not the destination party has a rejection profile associated therewith (block 225).

If the destination party does not have a rejection profile associated therewith (arrow 226), then the method may proceed by routing the incoming call to the destination party (block 230).

In contrast, if the destination party has a rejection profile associated therewith (arrow 227), then the method may proceed with the operations of block 235 and onward.

In some embodiments, the method may include, for example, checking whether or not the incoming phone call matches at least one rejection criterion in the rejection profile of the destination party (block 235).

If the incoming phone call does not match any rejection criterion in the rejection profile of the destination party (arrow 236), then the method may proceed by routing the incoming call to the destination party (block 230).

In contrast, if the incoming phone call matches at least one criterion in the rejection profile of the destination party (arrow 237), then the method may proceed with the operations of block 240 and onward.

In some embodiments, the method may include, for example, transferring a rejection response to the calling party, directly or indirectly (block 240).

In some embodiments, the method may include, for example, transferring to the calling party an offer to route the phone call to the destination party if the calling party agrees to incur all the charges associated with the phone call (block 245). Optionally, an estimate of the charges or of the destination party's charges (to be incurred by the calling party) may be conveyed to the calling party.

In some embodiments, the method may include, for example, checking whether or not the calling party accepts to incur all the charges associated with the phone call, including the charges that are typically associated with the receiving party (block 250).

If the calling party does not accept (arrow 251), then the method may proceed by terminating the phone call (block 255). In some embodiments, the method may include blocking or avoiding a connection or a routing of the phone call to its destination party, or disconnecting between the calling party and the destination party, or maintaining these parties disconnected from each other.

In contrast, if the calling party accepts (arrow 252), then the method may proceed with the operations of block 265 and onward.

In some embodiments, the method may include, for example, obtaining from the calling party the details of its payment method for all the charges associated with the phone call (block 265).

In some embodiments, the method may include, for example, routing the phone call to the destination party (block 270).

In some embodiments, the method may include, for example, collecting from the calling party all the charges associated with the phone call, including the charges that are typically incurred by the receiving party and not by the calling party (block 275).

In some embodiments, the method may include, for example, performing one or more billing operations to ensure that the receiving party is not charged in association with the phone call (block 280). This may include, for example, avoiding a charge or a debit to the receiving party in connection to the phone call; removing or deleting a charge or a debit that were already issued to the receiving party in connection with the phone call; or issuing a credit to the receiving party in an amount substantially equivalent to a charge or debit that were already issued to the receiving party in connection with the phone call.

Other suitable operations or sets of operations may be used.

Discussions herein utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Some embodiments may take the form of an entirely hardware embodiment, an entirely software embodiment, or an embodiment including both hardware and software elements. Some embodiments may be implemented in software, which includes but is not limited to firmware, resident software, microcode, or the like.

Furthermore, some embodiments may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

In some embodiments, the medium may be or may include an electronic, magnetic, optical, electromagnetic, InfraRed (IR), or semiconductor system (or apparatus or device) or a propagation medium. Some demonstrative examples of a computer-readable medium may include a semiconductor or solid state memory, magnetic tape, a removable computer diskette, a Random Access Memory (RAM), a Read-Only Memory (ROM), a rigid magnetic disk, an optical disk, or the like. Some demonstrative examples of optical disks include Compact Disk-Read-Only Memory (CD-ROM), Compact Disk-Read/Write (CD-R/W), DVD, or the like.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components may be used.

Some embodiments may be implemented by software, by hardware, or by any combination of software and/or hardware as may be suitable for specific applications or in accordance with specific design requirements. Some embodiments may include units and/or sub-units, which may be separate of each other or combined together, in whole or in part, and may be implemented using specific, multipurpose or general processors or controllers. Some embodiments may include buffers, registers, stacks, storage units and/or memory units, for temporary or long-term storage of data or in order to facilitate the operation of particular implementations.

Some embodiments may be implemented, for example, using a machine-readable medium or article which may store an instruction or a set of instructions that, if executed by a machine, cause the machine to perform a method and/or operations described herein. Such machine may include, for example, any suitable processing platform, computing platform, computing device, processing device, electronic device, electronic system, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit; for example, memory, removable or non-removable media, erasable or non-erasable media, writeable or re-writeable media, digital or analog media, hard disk drive, floppy disk, Compact Disk Read Only Memory (CD-ROM), Compact Disk Recordable (CD-R), Compact Disk Re-Writeable (CD-RW), optical disk, magnetic media, various types of Digital Versatile Disks (DVDs), a tape, a cassette, or the like. The instructions may include any suitable type of code, for example, source code, compiled code, interpreted code, executable code, static code, dynamic code, or the like, and may be implemented using any suitable high-level, low-level, object-oriented, visual, compiled and/or interpreted programming language, e.g., C, C++, Java, BASIC, Pascal, Fortran, Cobol, assembly language, machine code, or the like.

Functions, operations, components and/or features described herein with reference to one or more embodiments, may be combined with, or may be utilized in combination with, one or more other functions, operations, components and/or features described herein with reference to one or more other embodiments, or vice versa.

While certain features of some embodiments have been illustrated and described herein, many modifications, substitutions, changes, and equivalents may occur to those skilled in the art. Accordingly, the following claims are intended to cover all such modifications, substitutions, changes, and equivalents.

What is claimed is:

1. A method of routing a telephone call, the method comprising:
receiving from a first party a rejection profile, indicating that the first party wishes to reject an incoming telephone call which meet at least one criterion unless the first party is not charged for any charges associated with said incoming telephone call;
receiving a request of a second party to place a telephone call to said first party, wherein the telephone call is expected to incur one or more charges to the first party;
if the telephone call meets said at least one criterion of the rejection profile of the first party, notifying the second party that the telephone call is not routed to the first party unless the second party agrees to pay for all charges associated with said telephone call.

2. The method of claim 1, comprising:
obtaining acceptance of the second party to incur for all charges associated with said telephone call; and
connecting said telephone call between the second party and the first party.

3. The method of claim 2, comprising:
subsequent to obtaining the acceptance, and prior to connecting the telephone call, obtaining from the second party details of a payment method sufficient for collecting said charges from an account of the second party.

4. The method of claim 3, wherein the payment method is selected from the group consisting of: credit card of the second party, debit card of the second party, debit to a bank account of the second party, and debit to a telephony subscriber account of the second party.

5. The method of claim 4, wherein obtaining the details of the payment method comprises at least one of:
activating an automated voice-operated user interface to receive said details from the second user through a telephony device of the second user; and
activating an automated keypad-operated user interface to receive said details from the second user through a telephony device of the second user.

6. The method of claim 2, comprising, upon termination of said telephone call between the second party and the first party:
calculating charges associated with said telephone call and allocated to the first party;
notifying the second party of said calculated charges; and
debiting said calculated charges to a subscriber account of the second party.

7. The method of claim 2, comprising, upon termination of said telephone call between the second party and the first party:
if a subscriber account of the first party was debited for one or more charges, issuing a credit to the subscriber account of the first party in an amount substantially equal to said one or more charges.

8. The method of claim 1, wherein the at least one criterion is selected from the group consisting of: a geographical area in which the second party is located; at least a portion of a name of the second party; at least a portion of Caller ID information associated with the second party; an area code of the second party; an international dialing code of the second party; a time of day; and a day of week.

9. The method of claim 1, comprising, prior to obtaining the acceptance:
estimating charges associated with said telephone call and intended to be allocated to the first party;
notifying the second party of said estimated charges; and
obtaining an acceptance of the second party to incur said estimated charges instead of the first party.

10. The method of claim 1, wherein receiving the rejection profile comprises receiving the rejection profile through a configuration process performed by the first party through at least one of: a telephone device of the first party; and an automated voice-operated interface; an automated keypad-based interface; and an Internet page associated with a subscriber account of the first party.

11. A system for routing a telephone call, the system comprising:
a network element to receive from a first party a rejection profile, indicating that the first party wishes to reject an incoming telephone call which meet at least one criterion unless the first party is not charged for any charges associated with said incoming telephone call;
to receive a request of a second party to place a telephone call to said first party, wherein the telephone call is expected to incur one or more charges to the first party; and, if the telephone call meets said at least one criterion of the rejection profile of the first party, to notify the second party that the telephone call is not routed to the first party unless the second party agrees to pay for all charges associated with said telephone call.

12. The system of claim 11, wherein the network element is to obtain acceptance of the second party to incur for all charges associated with said telephone call; and to connect said telephone call between the second party and the first party.

13. The system of claim 12, wherein, subsequent to obtaining the acceptance, and prior to connecting the telephone call, the network element is to obtain from the second party details of a payment method sufficient for collecting said charges from an account of the second party.

14. The system of claim 13, wherein the payment method is selected from the group consisting of: credit card of the second party, debit card of the second party, debit to a bank account of the second party, and debit to a telephony subscriber account of the second party.

15. The system of claim 14, wherein the network element is to activate at least one of:
an automated voice-operated user interface to receive said details from the second user through a telephony device of the second user; and
an automated keypad-operated user interface to receive said details from the second user through a telephony device of the second user.

16. The system of claim 12, wherein, upon termination of said telephone call between the second party and the first party, the network element is to: calculate charges associated with said telephone call and allocated to the first party; notify the second party of said calculated charges; and debit said calculated charges to a subscriber account of the second party.

17. The system of claim 12, wherein, upon termination of said telephone call between the second party and the first party, and if a subscriber account of the first party was debited for one or more charges, the network element is to issue a credit to the subscriber account of the first party in an amount substantially equal to said one or more charges.

18. The system of claim 11, wherein the at least one criterion is selected from the group consisting of: a geographical area in which the second party is located; at least a portion of a name of the second party; at least a portion of Caller ID information associated with the second party; an area code of the second party; an international dialing code of the second party; a time of day; and a day of week.

19. The system of claim 11, wherein, prior to obtaining the acceptance, the network element is to: estimate charges associated with said telephone call and intended to be allocated to the first party; notify the second party of said estimated charges; and obtain an acceptance of the second party to incur said estimated charges instead of the first party.

20. The system of claim 11, wherein the network element is to receive the rejection profile through a configuration process performed by the first party through at least one of: a telephone device of the first party; and an automated voice-operated interface; an automated keypad-based interface; and an Internet page associated with a subscriber account of the first party.
